(19) United States
(12) Patent Application Publication
(10) Pub. No.: US 2004/0154169 A1
(43) Pub. Date: Aug. 12, 2004

(54) Locking folding knife with gas spring

(76) Inventor: Richard J. McCann, Spanaway, WA (US)

Correspondence Address: JAMES C. EAVES JR., GREENEBAUM DOLL & MCDONALD PLLC, 3500 NATIONAL CITY TOWER, 101 SOUTH FIFTH STREET, LOUISVILLE, KY, 40202, US

(21) Appl. No.: 10/772,136

(22) Filed: Feb. 4, 2004

Related U.S. Application Data
(60) Provisional application No. 60/445,083, filed on Feb. 5, 2003.

(51) Int. Cl. B26B 3/06

(52) U.S. Cl. 30/161

(57) ABSTRACT

Disclosed is a folding knife (10) having a handle (12) and a blade (14) mounted on a pivot axis (16). The blade (14) is locked in open (FIG. 4) and closed (FIG. 2) positions by a slidable latch member or bolt (22). The bolt (22) is biased toward the locked position by a gas spring (38) which operates as a sealed, gas filled, variable volume piston/cylinder unit.

### RELATED PROVISIONAL APPLICATION

This application claims the benefit of my Provisional Patent Application Serial No. 60/445,083, filed Feb. 5, 2003, for Locking Folding Knife with Gas Spring.

### TECHNICAL FIELD

This invention relates to a folding knife with a pivoting or retracting blade that is locked into an open position by a latch member, the latch member being biased by a gas spring.

### BACKGROUND OF THE INVENTION

Locking mechanisms for folding knife blades are well known and invariable include some type of displacable spring element or spring-biased element to block movement of the blade. A wide variety of metal springs that flex, rotate, compress, bend, or stretch have been employed. All such springs are subject to fatigue, breakage, seizing, or other failure.

### SUMMARY OF THE INVENTION

The present invention provides a folding knife which uses a compressible gas spring to bias a bolt or latch member into a blade-locking position. The gas spring includes a movable wall that partially defines a substantially sealed, variable volume chamber containing a gas. Such a gas spring is not subject to fatigue or breakage and is unlikely to be affected by corrosion or adverse conditions. It is believed that a gas spring has never before been used in a folding knife.

Other aspects and features of the present invention will be noted upon examination of the drawing, description of the best mode for carrying out the invention, and claims, all of which constitute disclosure of the present invention.

### BRIEF DESCRIPTION OF THE DRAWING

Like-reference numerals are used to represent like parts 1 throughout the various figures of the drawing wherein:

FIG. 1 is a cut-away pictorial view of a folding knife according to a preferred embodiment of the present invention;

FIG. 2 is a longitudinal sectional view in the closed position;

FIG. 3 is a longitudinal sectional view in a partially opened position;

FIG. 4 is a longitudinal sectional view in the open position;

FIG. 5 is a pictorial view in a closed position; and

FIG. 6 is a pictorial view in an open position.

### BEST MODE FOR CARRYING OUT THE INVENTION

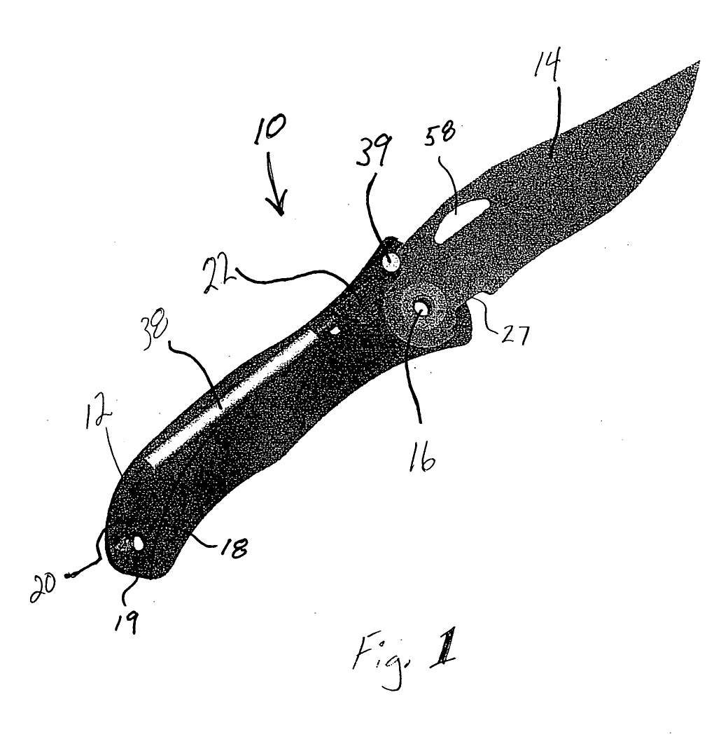

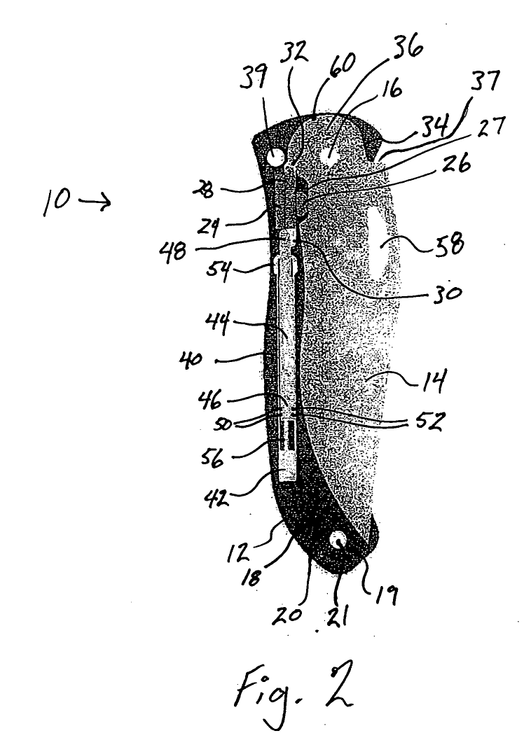

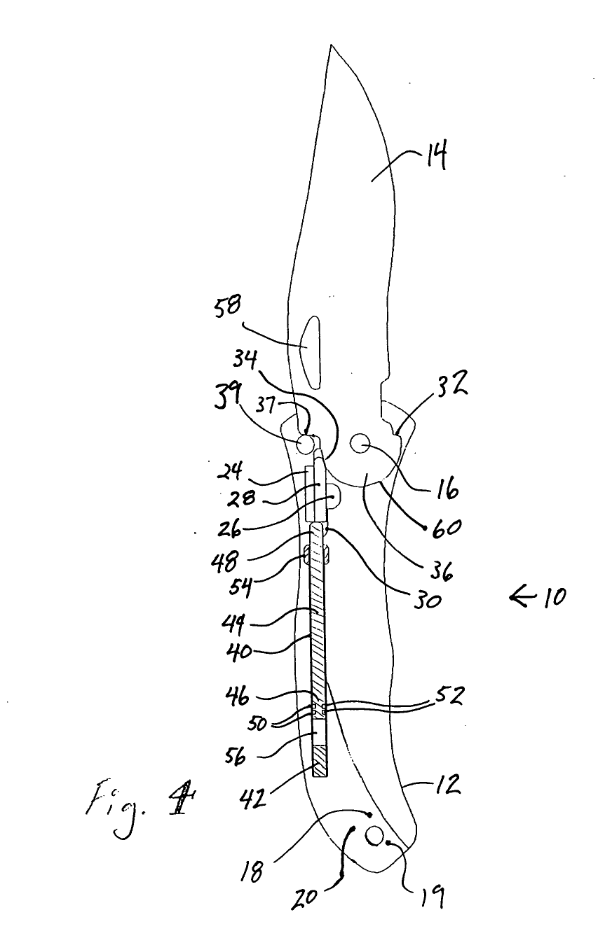

Referring to the various figures of the drawing, and first to FIG. 1, therein is shown at 10 a partially cut-away (one handle side removed) pictorial view of a knife according to a preferred embodiment of the present invention. The knife 10 includes a two-part handle 12 and a pivoting blade 14 of any desired length or shape. The blade 14 pivots on a shaft 16, which also serves to connect the handle halves 12, along with screws that pass through three other connection openings 18, 19, 20 which may be adjacent a lanyard opening 21. As is also shown in FIGS. 2-4, the blade 14 is locked into closed (FIG. 2) and open (FIG. 4) positions by a latch member or bolt 22. The bolt 22 may have one or more guide rails 24, 26 that are slidably received by guide slots formed between the two halves of the handle 12 when assembled. Guide rail 26 also acts as a stop member against which a non-sharpened portion (at notch 27) of the blade 14 rests when in a closed position (FIG. 2). This prevents the sharpened edge of the blade 14 from bearing against the handle 12 or gas spring 38 when closed. Grip portions 28 of the bolt 22 may extend laterally outwardly through openings 30 in the handle 12 for manipulation by the user. The bolt 22 engages notches 32, 34 in the tang porting 36 of the blade 14 when in the fully open and fully closed positions. A notch 37 in the blade 14 bears against an internal stop member 39 when fully open.

The bolt 22 is biased toward the locked position by a gas spring 38. A preferred embodiment of the gas spring is a linear, substantially sealed, variable-volume piston/cylinder unit filled with a fixed amount of gas, such as nitrogen (N₂). The gas spring 38 may include an elongated cylinder barrel or wall 40 that is substantially round in cross section. Stock brass tubing is an excellent material from which to construct the cylinder body. One end is closed with a solid head 42 which may be a brass plug made of round bar stock soldered in place to seal one end of the tube 40. Positioned within the cylinder 40 is an elongated piston 44 having a head end 46 and an outwardly-extending rod end 48. The head end 46 includes one, or preferably two, annular grooves 50 for receiving elastomeric O-rings 52.

The cylinder 40 may be capped 54 to guide the rod end 48 of the piston 44 and to capture the piston 44. This cap 54 need not be air tight because the gas spring 38 requires only one variable volume chamber 56. The cap 54 may also be provided with a wiper or dust shield (not shown), if desired. A lubricant (preferably dry) may be provided within the cylinder 40, if desired, but is not usually deemed necessary.

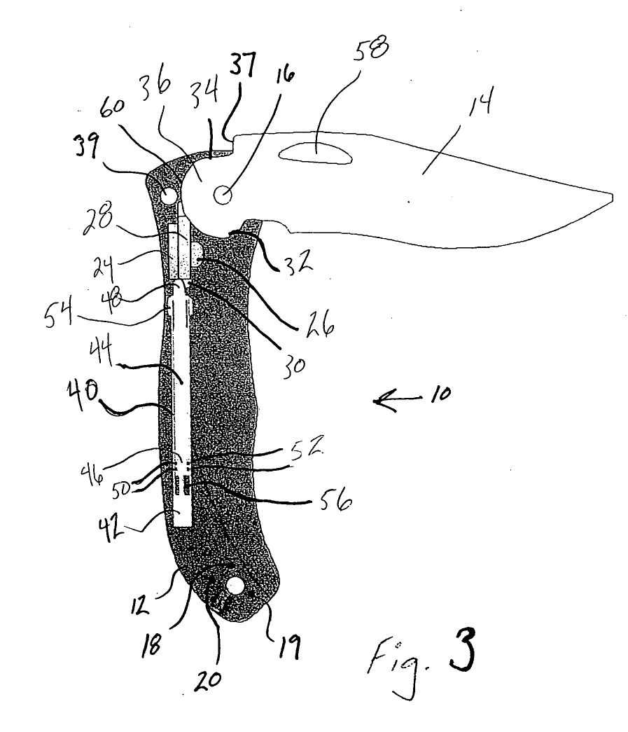

In operation, manual movement of the bolt 22 depresses the rod end 48 of the piston 44. The piston end 46 is moved to reduce the volume of the chamber 56, thereby compressing the captive gas and increasing its pressure against the piston member 44 (see FIG. 3). Releasing the bold 22 causes it to be spring biased back toward the locked position (see FIGS. 2 and 4).

Only a very short stroke length of the gas spring 38 is required to provide sufficient spring force and the length of the cylinder 40 and piston 44 may be reduced from that shown, if desired. A shortened piston/cylinder unit could allow for various handle shapes and designs as well as variations in the position or operation of the locking bolt 22 or other lock-operating member. A non-linear gas spring could also be employed, although it would be at significantly greater cost to construct than the illustrated embodiment. Because the elasticity of the gas in the chamber 56 does not fatigue, the spring 38 is not subject to the failures associated with bending springs described above. In the unlikely event of failure of both O-rings 52, the entire unit 38 may be replaced easily without any special tools.

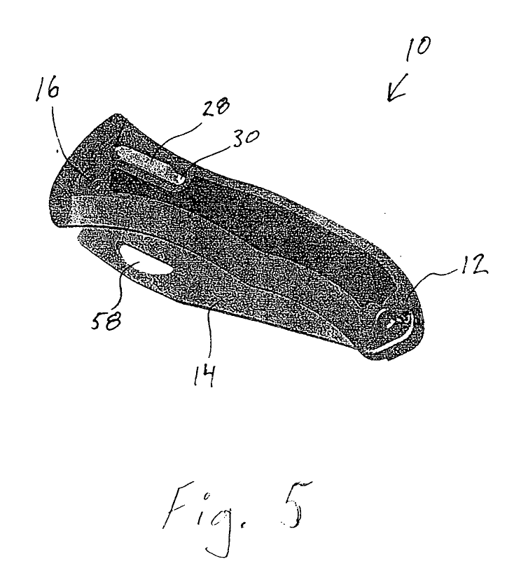

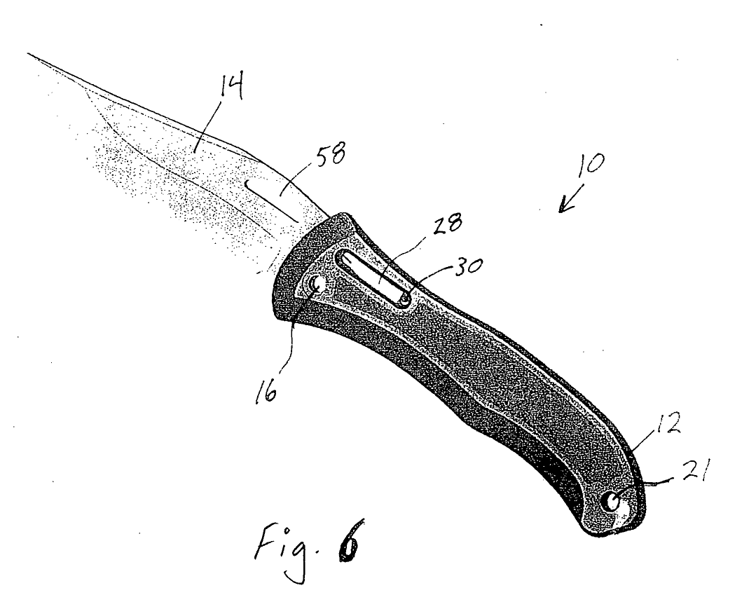

Referring now also to FIGS. 5 and 6, therein it can be seen that the grip portions 28 of the bolt 22 are exposed and project through the openings 30 the handle halves 12 for easy manipulation. The knife blade 14 may include a thumbnail slot or aperture 58 to assist manual opening of the blade 14. Alternately, a laterally-extending dog or post (not shown) may be provided on the blade 14 in a well-known manner to facilitate one-handed thumb opening of the blade 14. Additionally, the portion 60 of the tang 36 that bears against the bolt 22 between open and closed positions (see FIG. 3) may be formed with a slightly decreasing radius (spiral) such that the spring force by the bolt 22 bearing against it assists in the opening of the blade by offsetting other frictional forces. It is not contemplated that this feature would render the knife 10 self-opening. The present invention is intended to provide a gas spring for biasing a blade-locking member into position without respect to how the blade is extended or deployed.

The embodiment shown is that which is presently preferred by the inventor. Many variations in the construction or implementation of this invention can be made without substantially departing from the spirit and scope of the invention. Thus, the scope of patent rights are to be limited only by the following claim or claims interpreted according to accepted doctrines of claim interpretation, including the doctrine of equivalents and reversal of parts.

What I claim is:

1. A knife, comprising:
a handle;
a blade movably secured to the handle so that the blade is movable along a path of travel between a closed position and an open position;
a latch member movable between a locked position in which it extends into the path of travel of a portion of the blade thereby preventing movement of the blade and an unlocked position in which it does not interfere with movement of the blade;
a gas spring positioned to bias the latch member into the locked position, the gas spring comprising a movable wall that partially defines a substantially sealed, variable volume chamber containing a gas; and
wherein movement of the latch member from the locked position to the unlocked position causes the movable wall to reduce the volume of the chamber, thereby compressing the gas to create spring force against the latch member.

2. A folding knife, comprising:
a handle having a pivot shaft;
a blade movably secured to the handle so that the blade is pivotable about the pivot shaft along a path of travel between a closed position and an open position;
a latch member movable between a locked position in which it extends into the path of travel of a portion of the blade thereby preventing pivotal movement of the blade and an unlocked position in which it does not interfere with pivotal movement of the blade;
a gas spring positioned to bias the latch member into the locked position, the gas spring comprising a movable wall that partially defines a substantially sealed, variable volume chamber containing a gas; and
wherein movement of the latch member from the locked position to the unlocked position causes the movable wall to reduce the volume of the chamber, thereby compressing the gas to create spring force against the latch member.
